(19) United States
(12) Patent Application Publication
(10) Pub. No.: US 2002/0059132 A1
(43) Pub. Date: May 16, 2002

(54) Online bidding for a contract to provide a good or service

(76) Inventors: Steven C. Quay, Edmonds, WA (US); Dilip Worah, Bothell, WA (US); Brett V. Gaspers, Edmonds, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/930,908

(22) Filed: Aug. 16, 2001

Related U.S. Application Data
(60) Provisional application No. 60/226,476, filed on Aug. 18, 2000.

(51) Int. Cl. G06F 17/60

(52) U.S. Cl. 705/37

(57) ABSTRACT

The present invention provides a method, a system and a site for enhancing the efficiency of transactions involving a vendor of a good or service bidding on a contract to provide that good or service to a client desiring the good or service.

### BACKGROUND OF THE INVENTION

The process of a vendor of a good or service bidding for a contract to provide that good or service to a customer is often more inefficient than it needs to be due to the necessity of soliciting multiple bids on an individual basis from multiple vendors and manually comparing those bids. The economic inefficiency of the process is further compounded by the lack of a simple method for each vendor to be aware of the bids submitted by competing vendors. If the customer wishes to prompt the vendors into informed competition for the contract, the customer must inform the bidding vendors of lower or otherwise more attractive bids and request that they respond if so desired. The need for repeated cycles of bidding, informing and revising the bid can unnecessarily prolong the precontract negotiations and increase the cost to the customer of the good or service. One example of such a transaction in which vendors bid for a contract to provide a good or service is the bidding of contract research organizations for a contract to conduct a study on a new agent, device or procedure.

Prior to being placed on the market or otherwise utilized in the United States, or elsewhere in the world, a new therapeutic or diagnostic agent, medical device or medical procedure must pass through an exhaustive scientific and regulatory review process. Ready to assist researchers and pharmaceutical houses in the review process are a large number of contract research organizations, which conduct the experimental portions of the preclinical and clinical trials and monitor, gather and process the data that is produced in these trials. Presently, if an inventor or potential manufacturer of a new procedure, device or agent wishes to launch the new product along the road to regulatory approval with the assistance of a contract research organization, they must engage in a time-consuming search for an organization charging a reasonable price and having personnel with adequate qualifications and experience.

Other areas of the pharmaceutical, biotechnology and medical device industry that are outsourced include discovery research and commercialization of a product. Commercialization may include contract manufacturing, contract marketing, contract sales and contract distribution. Selection of a commercialization partner can be as time consuming as the selection of a contract research organization. All of these groups are referred to as contract service organizations in the remainder of this patent.

The process of choosing a contract service organization requires that each of a selected group of contract service organizations be informed individually of the parameters for the project of interest and make a bid on the project based on these parameters. The sponsor of the project must then consider each of the bids for their price, adherence to the defined parameters, use of equivalents of the parameters, quality of the organization personnel, etc. As each of the bids is made in isolation relative to the other bids, there is no real price competition between the contract research organizations built into the bidding process. Any price competition present in the process must be introduced by the study sponsor by, for example, contacting a first party submitting a higher bid with information about a lower bid submitted by a second party and providing the second party with the opportunity to counter the lower bid. The inefficiency in requiring a study sponsor to repeatedly contact a pool of bidders to obtain the lowest cost is apparent. A more efficient system relies on a computerized marketplace or Exchange, which allows project sponsors to post the parameters of a proposed project and contract research organizations to bid competitively on the cost of the project.

Computerized marketplaces of many kinds are well known in the art. They range from simple classified ad bulletin boards to complex mainframe-based market systems such as NASDAQ which offers a real-time market-making system for tens of thousands of securities brokers. All modem stock, bond and commodity exchanges are supported by underlying computerized databases and related systems which enable them to function.

Typically, electronic Exchanges are designed to facilitate commercial transactions of tokens of ownership, such as shares of stock, or physical objects such as ounces of gold or a used car. Other Exchanges specialize in the sale of information stored on databases such as that provided by Lexis/Nexis, where users pay fees for accessing articles while content providers are paid per article downloaded. Still other Exchanges provide matching services where each party is seeking an efficient way to find the other, such as might be provided by a dating service or a job bank.

Exchanges whose function is to support a marketplace for the buying and selling of consulting or contract research services have been few and far between. Since this type of Exchange supports a form of commercial activity which is meant to take place in the future, the Exchange's role is to serve as a structured meeting ground for the negotiation of the service to be provided. The advent of modes of rapid communication, such as the Internet, makes it possible to maintain an Exchange that supports the sale of consulting and contract research services.

Taking transactions conducted over the Internet as an example, numerous formats for the online negotiation for and sale of goods and services are known in the art. The auction or reverse auction is a popular format, which is principally associated with transactions involving goods; online auction systems for the transfer of motor vehicle ownership are a representative example of a “forward” auction. Berent et al., U.S. Pat. No. 5,774,873, describe an electronic auction and motor vehicle auction information system. The system allows users to interactively participate in auctions of motor vehicles using a personal computer. The Berent et al. system and other analogous systems, are classical auction systems; the product goes to the highest bidder. A classical auction format does not provide the opportunity for the input of specific parameters relevant to a study or other project into a database that can be queried by providers of the sought after goods or services. Moreover, a classical auction system does not allow for the input of progressively lower bids until the lowest bid is reached or the bidding cycle expires and the project is awarded to the lowest bidder.

Unlike a standard, “forward” auction in which bidders bid for a particular product, and the product is sold to the highest bidder, in a reverse auction the price of the product decreases in a set manner during the time period of the auction. The auction terminates when there is no more product to be sold or the time period of the auction expires. Computer-assisted reverse auctions for goods are known in the art. For example, Godin et al., U.S. Pat. No. 6,026,383, describe a method using a computer and the Internet for conducting a reverse auction. The Godin system, however, does not allow the user (purchaser) to input a set of parameters specific to a study or other desired good or service and solicit bids from organizations qualified to undertake the study or provide the good or service.

Quasi-reverse auctions for services or hybrids between goods and services are known. Johnson, et al., U.S. Pat. No. 5,995,602, discloses the use of a computer uses a computer referred to as a “bidding moderator” to manage bids for telecommunications services. Each of a plurality of telecommunications carriers bidding for traffic over a particular route informs the moderator of the rate that it is willing to charge for carrying traffic over that route. From the list of all carriers providing bid information to the moderator, each subscriber can select the carrier providing the lowest cost service. A similar auction format for the auction of energy (e.g., electricity, natural gas) is disclosed by Johnson et al, U.S. Pat. No. 6,047,274. Neither of these systems allow for the input of information regarding the parameters of a service or good of interest, nor do they allow for the querying of a database regarding the quality of the good of the qualifications of the personnel who are being considered as providers of the service.

A commercial network system that connects experts and those with queries for those experts, and that qualifies the experts to answer the queries is the subject of U.S. Pat. No. 5,862,223 to Walker et al. The network provides a computerized marketplace for those in need of information and the experts that can provide the needed information. The system maintains a database of biographical information for experts in a range of fields. The database can be queried by a user through a search request. Although the system creates a marketplace for expert services, it does not allow for competitive bidding between experts for a particular project.

The use of computers connected via a wide area network, such as the Internet, to assist in performing clinical trials is known in the art. Colon et al. describe a method and system for interactive prescription and distribution of prescriptions in conducting clinical studies (U.S. Pat. No. 5,991,731). The patent describes a computer method and system for managing data collected in clinical trials, which are simultaneously conducted at a number of geographically distinct centers. Each of the individual clinical sites has a computer for inputting data, transmitting and receiving data over the Internet. The system communicates data over the Internet to determine patient eligibility, randomization and initial prescriptions, which can then be adjusted by the physician online. Study data is maintained in a database in a host computer behind a firewall provided in the Internet server computer. Neither the disclosed system nor method provides for competitive bidding by contract research organizations for a project or study. Moreover, Colon et al. do not disclose maintaining a database including biographical data for the staff of a contract research organization.

A computer-facilitated method that allows a client to upload specifications for a desired product or service and which allows providers of the product or service to competitively bid for a contract to provide the product or service would decrease the price of the transaction and the goods or services underlying the transaction by introducing an element of efficient competition into the process. The present invention provides such a method and a system for practicing the method.

### SUMMARY OF THE INVENTION

The present invention provides a computer-facilitated method for bidding on a contract for providing goods and services. Also provided is a system for practicing the method of the invention and a computer site wherein the method resides. The method, system and site can be used for a number of different goods and services, including, but not limited to, chemicals, cargo space, consulting services, and contract research services. The discussion of the invention found herein focuses principally on an aspect of the invention in which a sponsor of a clinical study (“client”) uploads the parameters for the desired study to a wide area network, such as the Internet. Using the Internet, contract service organizations (“CSOs”) review the parameters for the desired study and enter bids for the contract to conduct the study. The focus of the discussion on this aspect of the invention is for clarity of illustration and is not intended to limit the scope of applications in which the present invention finds use. Those of skill in the art will recognize that there are many transactions that can be made more efficient by providing an electronic Exchange, which brings together clients and providers of goods and services.

The computer-facilitated method of the invention offers a number of advantages and efficiencies that are not presently obtainable with known methods of soliciting and receiving bids for performing a clinical study. The method of the invention creates an efficient Exchange that provides the opportunity for contract service organizations (“CSOs”) to competitively bid for a contract to perform a clinical study in an online format. The Exchange alleviates the necessity for a client to request individual bids from a number of CSOs. Moreover, the Exchange can operate as a clearing house for information about each CSO that subscribes to the Exchange or that participates in a bidding cycle for a particular study. By acting as a clearing house for information about various CSOs, the method of the invention eliminates the need for the client to visit many different sources to obtain the desired information.

Other objects and advantages of the present invention will be apparent to those of skill in the art upon review of the detailed description that follows.

### BRIEF DESCRIPTION OF THE DRAWINGS

FIG. 1 is a schematic diagram of a system of the present invention.

FIG. 2 is a block diagram of a row in the database of a system according to FIG. 1.

FIG. 3 is a block diagram of a software interface between Internet-network server and the database host computer of FIG. 1.

FIG. 4 is a schematic diagram of a representative page residing on a site of the invention.

### DETAILED DESCRIPTION OF THE INVENTION AND THE PREFERRED EMBODIMENTS

The present invention provides an electronic Exchange that facilitates the process of suppliers of goods and services bidding on a contract to provide those goods or services. Also provided is a system for practicing the method and a site wherein the method resides.

It is an object of the present invention to provide an efficient method of locating and matching qualified Contract Service Organizations (CSOs) to clients who desire the CSOs to perform all or a portion of the components that eventually lead to commercialization of a new agent, procedure or device. A further object of the present invention is the provision of an Exchange allowing the client to post the criteria for the desired study in a location accessible to a wide range of CSOs, which then competitively bid on the contract for the study. A still further object of the present invention is to allow the client the option of remaining anonymous during the bidding cycle. Moreover, the CSOs bidding for the project can optionally remain anonymous to each other and, if desired, to the client. Another object of the present invention is to provide to the client biographical information and technical qualifications of the staff of CSOs, thereby allowing the client to choose a CSO based on the expertise of its technical staff. A still further object of the invention is to allow the client to review prior work produced by a particular technical staff member or the CSO as a whole. Another object of the present invention is to establish a system whereby the CSO can be assured of receiving payment for its efforts on behalf of the client by, for example, verifying the client's ability to pay for the study, or setting up an escrow account to ensure payment. Yet another object of the present invention is to provide a real time connection between the client and the CSOs during which further negotiations can take place or additional details can be sought. A further object of the present invention is to provide a real time connection between two or more CSOs to arrange for a cooperative agreement vis-à-vis undertaking the study in a collaborative manner. Still another object of the invention is to provide the client secure access to data acquired from the study. Another object of the present invention is to provide a forum for clients to evaluate the quality of work performed by the CSOs participating in the Exchange.

Aspects of the invention and the presently preferred embodiments are discussed below.

A. The Method

The World Wide Web is the Internet's multimedia information retrieval system. In the web environment, remote workstations effect transactions to web servers using the Hypertext Transfer Protocol (HTTP), which is a known application protocol providing users access to files (e.g., text, graphics, images, sound, video, etc.) using a standard page description language known as Hypertext Markup Language (HTML). HTML provides basic document formatting and allows the developer to specify “links” to other servers and files. In the Internet paradigm, a network path to a server is identified by a so-called Uniform Resource Locator (URL) having a special syntax for defining a network connection. Use of an HTML-compatible browser (e.g., Netscape Navigator or Microsoft Internet Explorer) at a remote workstation involves specification of a link via the URL. In response, the workstation makes a request to the server identified in the link and, in return, receives a document or other object formatted according to HTML. A collection of documents supported on a web server is sometimes referred to as a web site.

One of the technical advantages of the World Wide Web is the ease with which information may be posted and retrieved by users. Any computer user may navigate to a web site of interest and obtain relevant information hosted by the site. Thus, in the contract service organization industry, many CSOs now have web sites that include descriptions of their staff and. A client (namely, an entity that desires the services of a CSO) may navigate to a CSO's web site using a conventional web browser and obtain useful information. While this approach is advantageous, a user cannot obtain competitive pricing information without having to query multiple third party sites and manually compare the information located during such searching. Moreover, many sites will not even provide pricing information to a user without the user first identifying itself (perhaps in a secure manner) to the CSO.

In a first aspect, the present invention provides a method for facilitating the electronic bidding for providing goods and services, wherein providers of the goods and services attempt to submit the lowest amount or highest quality bid to provide the goods or services solicited by a client.

In a preferred embodiment, the purchaser of the services (i.e., sponsor of the clinical trial) selects the components of the service to be provided from a list of components shown on a web page maintained by the Exchange. All components are standardized and pre-defined except for explanatory parameters entered by the purchaser (e.g., number of patients per arm of the trial). The system starts with a number of components, to which more are optionally added over time.

Service components include, but are not limited to, factors such as number of arms, blinding, use of passive and active controls, sample sizes, length of the trial, number of centers, trial phase, therapeutic area, endpoints and their evaluation, manufacture, distribution, marketing and sales of a drug product or medical device, and specific research services such as combitorial chemistry, screening assays or genome services.

The template components are stored in a relational database. When a template in the form of a web page is requested by the potential purchaser of services, the web server preferably delivers a web page with a list of controls (e.g., text entry boxes, drop-down menus, Java applets, ActiveX controls, browser plugins, etc.) displaying the different component choices, thereby allowing the client to fully describe the clinical trial of interest. In a preferred embodiment, the controls are populated by querying the database and loading the controls with the different values available for the template components.

Once the client has described the profile of the project, a button click on the web page stores the profile in the relational database. At this point, the profile is available for review by CSOs interested in reviewing the profile.

The electronic Exchange of the invention allows a CSO to preview the projects that are up for bid and, optionally, projects on which the bidding is closed and/or projects on which the bidding is anticipated to begin at a future date. The Exchange also allows a CSO to register as a bidder for a project that is being bid upon or that is anticipated to be bid upon at a future date.

CSOs are able to search clinical trials by a number of parameters, for example, calling up a list of all cardiovascular Phase II clinical trials. Vendors preferably open a web page containing a number of controls (of the types previously described) in order to select and specify search parameters for the different elements in a template. Once the vendor has specified the search parameters, those values are sent to the web server over the Internet, the search request is relayed to the relational database, and templates matching the request are returned to the user as a web page.

In a preferred embodiment, the bidding is that of contract research organizations for contracts to perform a clinical study. Potential bidders preferably connect to a web server with a web browser. The web server delivers a web page to a remote workstation operated by the bidder. The web page contains controls (e.g., text entry boxes, drop-down menus, Java applets, ActiveX controls, browser plugins, etc.) allowing the bidder to enter search criteria for any or all of the parameters relevant to a particular study. The parameters entered will conform to the parameters contained in a database. The web page optionally displays the full set of parameter choices or limits the display to a subset of parameters, which are selected by the bidder or predefined by the web server.

After a potential bidder has selected the parameters to review and has entered specific search criteria for those parameters, the bidder transmits the search request back to the web server over the Internet. The web server will formulate the search criteria into a SQL query, which is submitted to the database. The database transfers the records returned by the query to the web server, which formats the records into a web page and sends the web page back to the bidder.

In a preferred embodiment, the Exchange has a menu screen, which provides command buttons for “Study Schedule,” which allows the CSO to receive a listing of studies that are presently up for bid or that will be up for bid in the future. The information provided optionally includes one or more of, for example, day, date, time, title of the study, summary of the study parameters and study sponsor.

In one embodiment, the CSO (“user”) initiates an on-line pre-bidding Registration routine. At the pre-bidding registration menu, clicking on a “Register for Bidding” button, or its equivalent, permits user selection of a particular study or studies to register for. The application then prompts the user for any changes to be made to the data on file for the CSO. After entering any new data or declining to make such an entry, the user is preferably prompted to accept the conditions, terms and rules associated with the Exchange. Finally, a message will appear confirming that the user has successfully registered for a specific bidding cycle on a particular study. In a preferred embodiment, the user is provided with a personal identification number (“PIN”), which must be entered at the main menu each time access to the Exchange is sought. The PIN can be used in a number of different formats. For example, in one embodiment, a PIN is issued to a particular user and that PIN is effective across every bidding cycle for every study. In another embodiment, prior to issuing the PIN, the user is prequalified by, for example, matching study parameters with characteristics and qualifications of the staff of the CSO by comparing the study parameters with items maintained in the database maintained of the system of the invention. If there is less than a preselected degree of match between the study parameters and the qualifications of the CSO, a PIN for a particular study is not issued to the applying CSO. Other qualifying factors for bidders are optionally specified by the client (e.g., degree of satisfaction of previous client, aggregate number of years of experience, geographical location, expertise in particular families of agents or medical devices, etc.). Once it is issued, the PIN can be sent to the user by e-mail, regular mail, telephonically or the like.

The embodiment of the invention utilizing a PIN works well in low security applications. Due to the proprietary nature of much of the information associated with clinical studies, there are provided embodiments of the invention in which the security of the method is further enhanced by the use of cryptographic methods. These methods not only enhance the ability to authenticate the client and the CSO, but also serve to authenticate the integrity of the bid or the posting of the study parameters, proving that it has not been altered during transmission. Encryption can also prevent eavesdroppers from learning the identity of the client and/or the bidders, and the contents of web page containing the study parameters, and the databases integrated into the system of the invention. Such techniques are referred to as “cryptographic assurance methods” and include the use, for example, of both symmetric and asymmetric keys as well as digital signatures and hash algorithms.

The practice of cryptographic protocols to ensure the authenticity of senders as well as the integrity of messages is well known in the art and need not be described here in detail. For reference, one of ordinary skill may refer to numerous references, such as, Schneier, APPLIED CRYPTOGRAPHY: PROTOCOLS, ALGORITHMS, AND SOURCE CODE IN C, 2nd Ed., John Wiley and Sons, Inc. 1996.

The ability of bidders to see projects up for bid is restricted to qualified bidders at the option of the client. Bidders are identified by, for example, a digital security certificate or other such mechanism (e.g. browser cookies). The purchaser could restrict the transaction either to specified bidders (all bidders must register prior to bidding on projects) or to bidders whose profiles match criteria specified by the purchaser. No other bidders would not be able to see the project in a list or find the project via a search.

Prior to actually bidding on a contract for a study, the user receives, by online file down load, or by diskette, the parameters of the study. The information is preferably imported into the user's PC at the CSO location to allow the user to review the parameters of the study prior to bidding on the study.

Another important routine within the Exchange application is the actual bidding process. After the purchaser has specified the template parameters, the transactional process begins. This happens in either a passive form, where the project may be displayed on a web page for presentation to potential bidders, or in an active form, where potential bidders can be notified of the existence of the project.

In the passive form, the project is preferably included in a list of all projects or projects by particular categories (such as phase or therapeutic area) or the project is optionally searched by the process described above, or its equivalent. Once a vendor has identified a project of interest, the vendor can enter into the bidding process for the project. In the active form, the purchaser could specify vendors of interest or a vendor profile to automatically include vendors who meet criteria of importance to the purchaser. Contacts at each vendor would then be notified via e-mail that a new project was available for bidding.

The process allows the users to bid on a specified study prior to the closing of the bid period. In a preferred embodiment, to begin the bidding process, the user clicks on the “Activate Bidding” command button, or its equivalent, at the “Electronic Bidding” menu. At that time, the user is preferably prompted for the PIN number corresponding to the user. After entry of the PIN, the bidding main screen appears. The bidding main screen includes information identifying the study. The bid screen optionally also includes updated information regarding the number of bids received, the number of CSOs bidding on the study and the bid that is currently the lowest.

During the bidding process, and while the bid screen is displayed, the user may click on an “Enter Bid” command button to place a bid on the study. The bid status section of the screen will then display “bidding” to confirm that the bid was entered from the user's workstation to the host network. When the user's bid is accepted, words to the effect, “you are the low bidder” appear in the status section of the bid screen. When the time period for the bidding has elapsed, a message appears in the status section to the effect, “the bidding is now ended.”

After the completion of the bidding cycle, the client has the opportunity to review the bids by the various CSOs and choose from amongst the bidders, the CSO that appears most qualified to perform the study at the best price. Following the completion of the bidding cycle, it is usually desired that the identities of the client and the CSO be made known to each other.

As mentioned previously, the present invention optionally provides for the anonymity of both the client and the CSO during the bidding process. Such anonymity is accomplished by eliminating all references to the names of the entities throughout the bidding cycle. In one embodiment, a CSO would include in its bid an identification number provided to it by the system of the invention rather than the name of the CSO. The client might follow a similar course. Many other ways to keep portions of the transaction anonymous are known in the art. For example, the ID numbers can themselves be encrypted.

The Exchange also provides clients with the ability to rate vendor service after projects have been completed. Vendors are rated on a number of parameters, such as satisfaction with vendor quality and speed, quoted cost vs. actual cost, quoted time to project completion vs. actual time to completion, and accuracy of data collection and analysis. During or after the bidding process, the ratings are optionally combined with the amount of the bids themselves and quoted contract timelines to give purchasers an overall assessment of the value of each bid. This provides purchasers the ability to select vendors on qualities other than price alone.

B. The System

In a second aspect, the present invention provides a computer system for linking a client desiring to have a study performed with one or more CSOs with the capacity to perform the study. The system includes a host computer network with a database server that electronically stores and organizes data about CSOs and that retrieves and transmits selected portions of the CSO data in response to client commands. The host computer network also maintains a database containing data about studies that are currently up for bid. A further database that includes bidding information on the studies currently up for bid is also maintained by the host computer network. Also provided are computer workstations placed at locations accessible to each client and/or CSO. The computer workstations preferably include a video monitor, means to send client and/or CSO commands to the host computer network, and means to receive and display data retrieved from the host computer network. The system also includes a communications network electronically linking the computer workstations and the host computer network. A presently preferred communications network is a wide area network, such as the Internet. The system of the invention also provides a set of user application modules, which cause the computer workstations and the host computer network to generate on the video monitors a series of command options selectable by the user to generate the user commands, whereby the selected portions of the CSO project data stored on the host computer network are located, organized and transmitted over the communications network to a workstation ins response to one or more particular user commands and are displayed on the video monitors. Also provided is an electronic bidding module associated with the workstation and host computer network that allows the CSOs to electronically place bids for studies currently up for bid.

A. The System

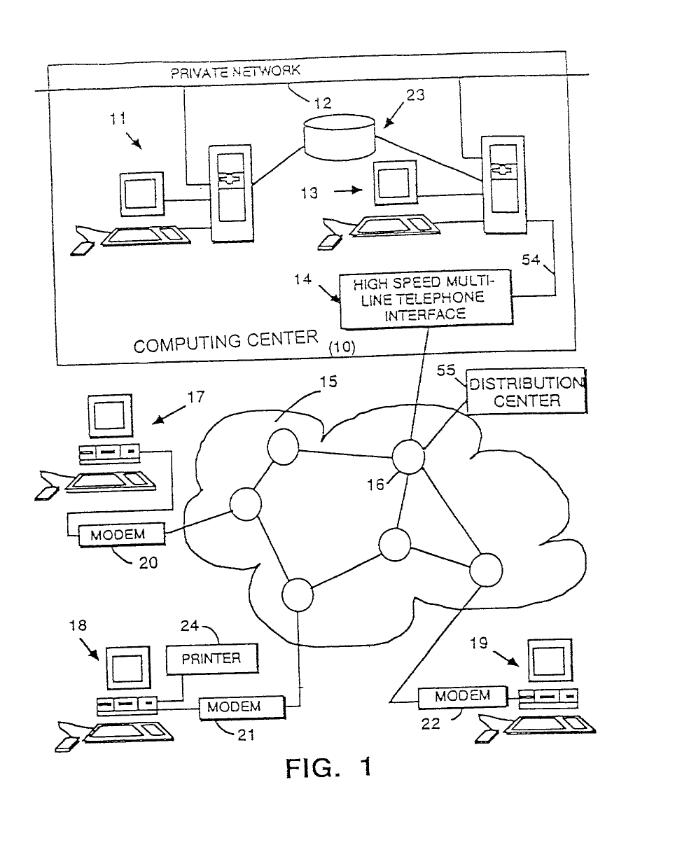

One preferred embodiment of the system of the invention is understood by referring to FIG. 1. A preferred system of the present invention includes a host computer network 10, also referred to more generally as a computing center 10, at a particular geographical site. The computing center 10 has a database host computer 11 connected via a 100-Mbit private network 12 to an Internet (Worldwide Web site) server 13. The private network 12 uses known LAN technology, but is not generally accessible to users outside the computing center 10. The Internet server 13 is equipped with two Ethernet adapters (not shown), one of which connects to the private network 12 for communication with the database host computer 11. The Internet server 13 is connected through the other Ethernet adapter to a local area network (LAN) 54, which in turn connects to a high speed multi-line telephone interface 14. This interface 14 connects through the Worldwide Web (Internet) network 15 and its many nodes 16 to computers 17, 18 and 19 at numerous research facilities (e.g., universities, pharmaceutical houses, etc.) and CSOs throughout the country, and possibly outside the country. These remote computers 17, 18 and 19 typically connect through modems 20, 21 and 22 to the Internet 15. The remote sites may include the offices of the sponsor of the project, and the offices of the project managers and offices of government agencies.

The database host computer 11 is preferably at least a 166-Mhz Pentium-based computer running the Windows NT operating system and database application software. The database application software is preferably the Oracle Relational Database Management System (DBMS), which is used to store study data, bid data, CSO personnel data, etc. Each type of data is stored in a separate table. Tables are joined as needed to produce regional and study-level management summaries and databases for statistical analysis.

The Internet server 13 is preferably a SUN Microsystems Ultrasparc server running the Solaris 2.5 operating system. The server 13 provides Internet network services to all authorized users over the Internet. The server 13 is also preferably loaded with Netscape Enterprise Server software, which is used to respond to all requests. Authorization is done in real-time against a management database stored behind a firewall on a database host computer 11. The Ultrasparc server 13 provides the firewall between outside connections to the Internet and its connection on a private network 12 to the database host computer 11.

The Internet server 13 preferably uses the Netscape Secure Server software with a Verisign Certificate of Authentication to provide encryption of all material moving to and from the central Internet server. Secure socket layer level 3 security will be performed at the Internet server 13 using RSA 40-bit encryption (international standard). This encryption system is sufficiently difficult to break that it is the international standard for secure commercial activity on the Internet.

JavaScript is used to create a script to implement client-side validation in real-time of data entry attempts. Each field in the online input forms will be checked in real-time for valid values. Only valid values are permitted to pass into the data system.

The computers 17, 18 and 19 at the clinical study participation sites connect to the Internet (Worldwide Web) 15 through local Internet Access Points which exist throughout the geographical regions in which, for example, the CSOs and clients are located. Site investigators are provided with Internet access in order to participate. The computers 17, 18 and 19 at, for example, the CSO or research sites are preferably IBM-PC compatible computers running the Windows '95 operating system, however, Apple Macintosh computers, IBM-PC compatible computers running Windows NT, Windows 3.1, and Unix-compatible Computers running Solaris (Sun UNIX), AIX (IBM UNIX), and Linux (public UNIX) can also be used.

The Internet server 13 (Web Site) and database are backed up. A RAID level 5 disk mirroring system 23 is used to provide redundant online swappable disk storage. The system will automatically switch to a mirrored back-up drive with no loss of service. The failed drive can be removed from the system and replaced with a functional drive without having the Internet network server 13 or database host computer experience downtime.

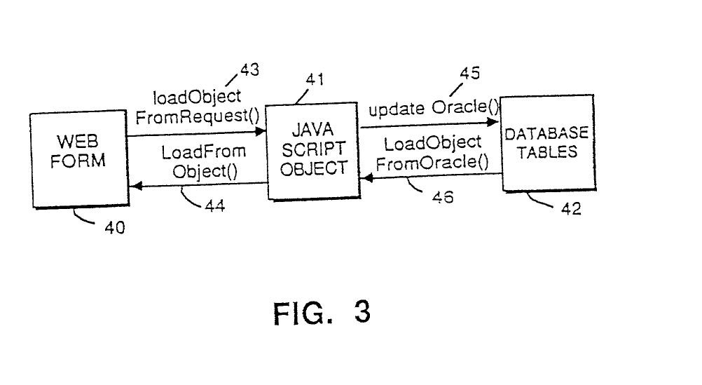

The Internet Server preferably runs Netscape “Livewire” application software behind the firewall to move data to and from the database on host computer 11. Referring to FIG. 3, a JavaScript object 41 is designed to run on the Internet server 13 to mediate the passage of data between the Internet server 13 and the database host computer 11. This object 41 has an element of data for each element of data that is either part of the database tables (represented collectively by element 42 in FIG. 3) or used in one of the Internet database input forms 40 communicated between the Internet server 13 and the remote site computers 17, 18 and 19. Some items may only be found on input forms 40 such as the date (day, month, year), while other items may only be in the database tables 42 (row stamp values, for example). The JavaScript object 41 is used to retrieve values from the database tables 42 and send them to forms viewed on the computers 17, 18 and 19 at the remote sites, and the JavaScript object 41 is also used to retrieve values input to the forms and store them in the database. This script simplifies the programming required to keep track of the types of data elements used in the forms, as well as their disposition, checking and validation. One object 41 is provided for each form 40. Several forms 40 may be used to provide views to tables 42 in the database.

Also shown in FIG. 3 are the functions which are executed to actually transfer data. The function “LoadObject FromRequest( )” 43 moves data from the form 40 to the object 41. The function “updateOracle( )” 45 moves data from the object 41 to the database tables 42. The function “LoadObject FromOracle( )” 46 moves data from the database tables 42 to the object 41. The function “LoadFromObject( )” 44 moves data from the object 41 to the form 40.

1. The Databases

As discussed above the present invention provides a number of databases that store, organize and provide access to information relevant to the bidding process for a particular study. A user is able to search and organize the information stored on the database by querying the database using

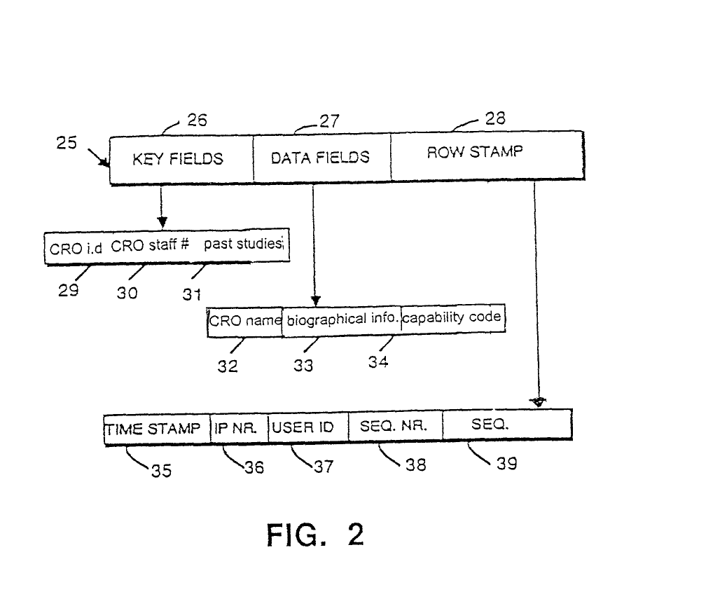

FIG. 2 illustrates the organization of a single row 25 in a database table. Each table has rows corresponding to real-world items of interest. Each row has three sections referred as key fields 26, data fields 27 and a row stamp 28.

Key fields 26 provide user-view identifiers for rows. Examples include CSO identification data 29, CSO staff number data 30, and studied performed by CSO data 31. Users typically use values of key fields to locate and choose rows 25. Key values may or may not be unique in the table. By use of sequences (see below), key field values cannot be edited without damage to the integrity of the database.

Data fields 27 contain the information to be recorded on the row 25. Examples include alphanumeric data such as CSO names 32, biographical information fields for staff member data 33, and binary values such as presence or absence of a particular capability or capacity 34.

Each row 25 contains a collection of attributes collectively referred to as the row stamp 28 and used to identify and process the record. A time stamp 35 is provided in the form of a date and time (GMT) this record was created. The time stamp is followed by an Internet Protocol number 36 of the computer used to create this record. By recording IP numbers 36 the number of computers used to access the database can be determined. A User ID 37 is assigned to each participating CSO. The User ID 37 of the operator is recorded on each record to identify the entity making the change. Each record in the table is given a primary sequence number 38, generated consecutively across the lifetime of the table. Each record contains a secondary sequence number 39 to distinguish from the original record from which an edit copy of the record was derived. On original records, the secondary sequence number 39 and the primary sequence number 38 are identical. On edited copies of the row, the secondary sequence numbers 39 will increase with each edit.

Each row 25 corresponds to an instance of the record at a particular moment in time. As the record is changed, new copies of the record are generated. By counting the number of record copies, the number of times the record has been edited can be determined. By ordering records by time stamp 35, a history of all changes to the record can be maintained. By selecting the record whose time stamp 35 is the next closest one before a particular data, the database can be easily rolled back to any point in time.

a. CSO Database

The invention provides a database that contains information about the CSOs that are participants in the Exchange. Vendors of products or services will enter profile information through a web browser page on which will be, for example, drop down menus (for standardized information) and text entry boxes (for information unique to the vendor). Data entry may also be accomplished through such means as Java applets, ActiveX controls, plugins, or other such automation technologies used in web browsers.

Once the vendor has completed the profile, the information is transmitted over the Internet (preferably using either SS1 or non-encrypted means) to a web server connected to a database. The web server will route the profile information to a database (e.g. a relational database), where the data is searched by, for example, standard SQL queries.

Profiling criteria may include information such as, for example, location of CSO, years in operation, number of staff, and biographical information for staff members. Other relevant information can include staff retention, ongoing staff training programs, and travel rate of staff. The database also preferably contains data concerning other studies that the CSO has performed and areas in which the CSO has expertise. Data of interest for inclusion in a database include, for example, expertise in clinical data management, statistics, safety surveillance, project management and planning, medical monitoring, recruitment of investigators outside the CSO, therapeutic areas.

Regarding data management, a study sponsor may wish to query the database about a CSOs database design, data capture methods (e.g., continuous or batch modes, remote data entry, single or double data entry and data entry verification), data review and coding methods (e.g., manual review, coding of adverse events and concomitant medication, computerized data discrepancy checks), database documentation methods and project management (e.g., data flow control, data discrepancy management, status and progress reports).

The study sponsor may also wish to query the database regarding how a CSO initiates a study and monitors a site. The database can include data relevant to research site selection and evaluation, investigator's meetings, personnel training and site initiation. Also of interest is source document validation, first review of case report forms, monitoring of enrollment rate and patient eligibility criteria. Furthermore, the client may wish to receive information regarding research site liaison and tracking of case report forms and data validation/resolution forms.

In certain instances, a client will desire the assistance of a CSO in developing a clinical program or trial. In such instances, the client may wish to query the database regarding the availability of planning from pre-clinical studies to phase III and beyond. The client may also wish for a critical review of already completed studies or portions of studies. A client may also choose a CSO based on its ability to provide literature reviews and meta-analysis, prepare and submit INDs, perform medical writing, author manuscripts, edit for publication and organize and attend meetings with FDA and other regulatory agencies. The database will preferably include information regarding which CSOs are capable of performing each of these tasks.

The database can also include information about the regulatory services and auditing capacity of the CSO. Relevant data include, for example, the ability of the CSO to ensure compliance with guidelines and regulations, obtaining clinical program approvals, provide safety updates, integrated safety and efficacy reports, study site audits, study management audits, and audit of data management and biostatistics.

b. Study Database

The system preferably provides a database that houses information regarding the studies that are presently up for bid. The information is generally entered by the client interested in having a study performed. The study database can also serve as a clearing house for information of a general nature about clinical studies. The database can also include literature references, reviews of methods and techniques relevant to clinical studies, links to other relevant sites and the like.

c. Other Databases

In addition to the databases storing study parameters and data relevant to a CSO, the system, method and site of the present invention can make use of a database which stores information about the bidding in past bid cycles for other projects. By querying this database a client or CSO can review the bids that were placed on past projects. The ability to review past bidding cycles allows a client to determine whether a particular bid is reasonable by comparing it to previous bids. The database also allows a CSO to determine the reasonableness of its bid by comparing the proposed bid to those placed for past projects. Yet another useful database houses information about the individual clients, including, for example, reviews of the client by other CSOs that have worked with the client, financial information, and the like. The client database assists the CSO in its decision whether to become involved in a transaction with the client.

2. The Site

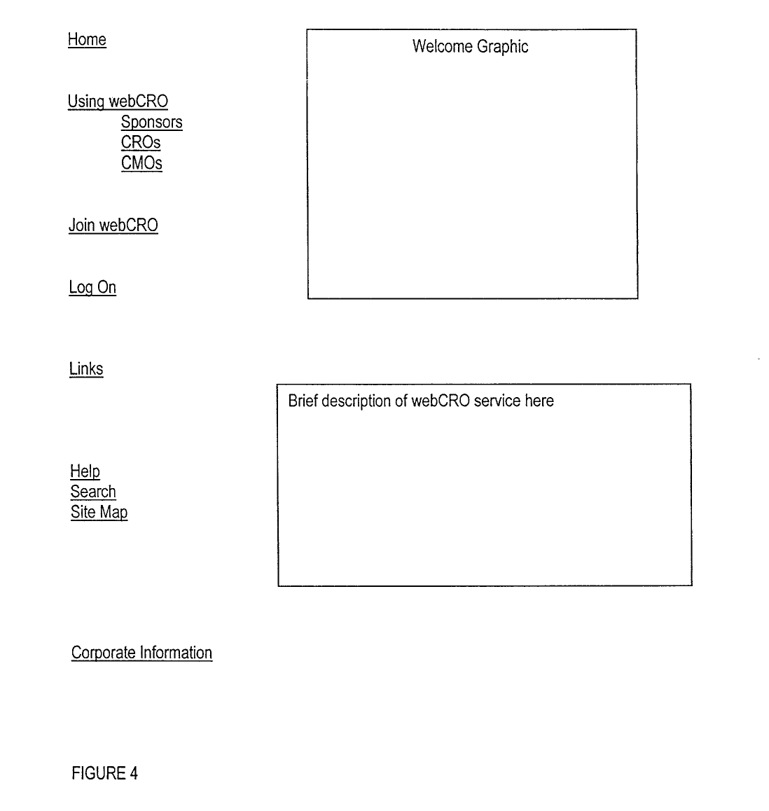

Also within the scope of the present invention is a computer site. A schematic diagram of a representative page on the site is set forth in FIG. 4. The computer site provides for the display, retrieval and input of data relevant to the method of the invention including, but is not limited to, data about a good or service, data about a provider of a good or a service, data about a user of the service, data about upcoming and/or completed auctions and data about ongoing auctions (e.g., time remaining, current price, number of bids, identity of bidders, identity of user, etc.). The web site also optionally provides for the display, retrieval and input of information that is not directly relevant to practicing the method of the invention, including, for example, advertising banners, links to other sites of interest and the like.

All publications and patent documents cited in this application are incorporated by reference in their entirety for all purposes to the same extent as if each individual publication or patent document were so individually denoted. Applicants do not admit by their citation of various references in this document that any particular reference is “prior art” to their invention.

What is claimed is:

1. A method of bidding for outsourced pharmaceutical or medical device good or service for a client requesting said goods and services, said method comprising:
(a) posting a proprietary template descriptive of said good or service to an interactive online bidding site;
(b) accepting from a first entity a bid to provide said good or service from a registered provider of said good or service.

2. The method according to claim 1 further comprising, in response to a request from a second entity to the server identifying a given good or service up for bid, identifying a current set of bids for said good or service.

3. The method according to claim 1 where the client can observe live bidding for the project on the internet.

4. The method according to claim 1, wherein said provider of a good or service is a contract service organization with expertise in the project under consideration.

5. The method according to claim 1, wherein said client is a member selected from the group consisting of a developer or manufacturer of a medical device, a developer or manufacturer of a medical procedure, a developer or manufacturer of a diagnostic agent, a developer or manufacturer of a therapeutic agent and combinations thereof.

6. The method according to claim 1 where access to the web site is by secure means and bidding process is restricted to authorized users only.

7. The method according to claim 1 where the identity of the sponsor may be optionally disclosed to bidders or potential bidders.

8. The method according to claim 1, wherein potential bidders are notified through an electronic message of the availability of all new auctions or only those auctions matching a predetermined profile of contract service organization abilities or interests.

9. The method according to claim 1, where potential bidders determine the availability of new auctions by viewing a web page showing all new auctions or only those auctions matching a predetermined profile of contract service organization abilities or interests.

10. A computer site for a supplier of a good or service to bid on a client request for bids on said good or service, said site comprising at least one web computer server serving a plurality of computer browsers and enabling said browsers with to participate in at least one bidding cycle, wherein said at least one bidding cycle is initiated by a client requesting entry of bids by suppliers of a good or service, said web server communicating with a separate database computer separated from said web server by a firewall, said database computer being accessible to said at least one web computer server to allow retrieval of information relevant to said good or service open for bid, said web server computer including application software for bidding on said good or service open for bid by:
(a) displaying to each said browser during a bidding cycle a parameter for said good or service up for bid;
(b) displaying to each said browser a current bid for said good or service up for bid, and a measure of time remaining in said bidding cycle;
(c) providing a user control for indicating instructions to enter a bid to provide said good or service open for bid; and
(d) updating to each said browser said current bid and said measure of time remaining in said bidding cycle to provide dynamic feedback to each said browser.

11. The computer site according to claim 10 wherein said database computer is accessible to said at least one web computer server to allow retrieval of information relevant to said supplier of a good or service.

12. A system for an interactive electronic Exchange between a client desiring to acquire a good or service and a provider of said good or service, said Exchange providing information to said provider about said good or service desired by said client and further allowing said supplier to enter a bid for providing said good or service, said system comprising:
(a) a host computer network including a database server that electronically stores and organizes data relevant to said good or service;
(b) a display component for displaying information to a user, said display component connected to a wide area network for inputting data about a first good or service desired by a client, wherein said good or service has a first parameter associated therewith; and
(c) a server connected to a wide area network for storing said first parameter.
